(19) United States
(12) Patent Application Publication
(10) Pub. No.: US 2017/0253182 A1
(43) Pub. Date: Sep. 7, 2017

(54) DRIVE ASSISTANCE DEVICE AND DRIVE ASSISTANCE METHOD

(71) Applicant: HONDA MOTOR CO., LTD., MINATO-KU, TOKYO (JP)

(72) Inventors: Junichi AOKI, SAITAMA (JP); Hiroyuki KOIBUCHI, SAITAMA (JP); Daisuke KONDO, SAITAMA (JP)

(73) Assignee: HONDA MOTOR CO., LTD., MINATO-KU, TOKYO (JP)

(21) Appl. No.: 15/505,849

(22) PCT Filed: May 21, 2015
(86) PCT No.: PCT/JP2015/064609

§ 371 Date: Feb. 22, 2017

(30) Foreign Application Priority Data
Aug. 27, 2014 (JP) 2014-172381
Aug. 27, 2014 (JP) 2014-172382

(51) Int. Cl. B60R 1/00; G06K 9/00; G01C 21/26

(52) U.S. Cl. CPC B60R 1/002; G01C 21/265; G06K 9/00805; G06K 9/00798; B60R 2300/207; B60R 2300/20; B60R 2300/301; B60R 2300/802; B60R 2300/8093; G08G 1/16

(57) ABSTRACT

A drive assistance device 10 includes a road information acquisition unit 12, an information display unit 5, a drive assistance unit 15, and a display control unit 14 configured to report road information in front of a vehicle 1 acquired by the road information acquisition unit 12, by displaying a road image portion R indicating a shape of a road and left and right outer edges EL, ER of the road image portion R in different colors on the information display unit 5, and to display a vehicle state display part C indicating an execution state of drive assistance by the drive assistance unit 15.

### TECHNICAL FIELD

The present invention relates to a drive assistance device and a drive assistance method that report the actuation status of a drive assistance function included in a vehicle.

### BACKGROUND ART

In recent years, a drive assistance device that performs drive assistance for a driver of a vehicle has become widespread. Examples of the function of the drive assistance include a function to inform the driver that the vehicle has come close to a curve by applying repelling force to an accelerator pedal, and a function to perform the steering so as to assist the steering operation when the speed of the approach to a curve is too high. When such drive assistance is performed, the execution status of the drive assistance is displayed on a display part provided in a meter panel or the like, in order not to give a feeling of unease and a feeling of strangeness to the driver of the vehicle.

Further, there is known a device to display a road shape image indicating the shape of a road on which the vehicle is traveling, on a display part of a head-up display that is projected in front of the driver (see Patent Literature 1, for example). The device displays an arrow index provided along the road shape image and a numerical index indicating the curvature of the road, and thereby, informs the driver that the vehicle has come close to a sharp curve. Further, the device displays in red an area of the road shape image to which the vehicle has come close, and thereby, warns the driver that the vehicle has come close to a center line or a left lane line.

### CITATION LIST

### Patent Literature

Patent Literature 1: Japanese Patent Laid-Open No. 2005-145434

### SUMMARY OF INVENTION

### Technical Problem

However, in the case where the display timing of the execution status of the drive assistance described above coincides with the display timing of the warning of the road shape, there is a fear that the driver neglects the care for the front of the vehicle because of watching the multiple display parts.

The present invention has been made in view of such a background, and has an object to provide a drive assistance device that allows the driver to easily recognize both the change in the road shape and the execution status of the drive assistance.

### Solution to Problem

A drive assistance device of the present invention, which has been made for achieving the above object, comprises:
a road information acquisition unit configured to acquire road information of a road on which a vehicle is traveling, the road information containing a shape of the road;
an information display unit configured to display information at a position that is visible from a driver of the vehicle;
a drive assistance unit configured to perform drive assistance for the driver of the vehicle; and
a display control unit configured to display the road information in front of the vehicle acquired by the road information acquisition unit on the information display unit such that a color of a road image portion indicating the shape of the road is different from a color of right and left outer edges of the road image portion, and to report an execution state of the drive assistance by the drive assistance unit by changing a display color of the outer edges depending on the execution of the drive assistance by the drive assistance unit, or by displaying a vehicle state display part indicating the execution state of the drive assistance by the drive assistance unit on the information display unit.

In the drive assistance device of the present invention, the road information acquisition unit acquires the road information in front of the vehicle, and the display control unit displays, on the information display unit, the road image portion indicating the shape of the road and the right and left outer edges of the road image portion, in different colors. Further, the execution state of the drive assistance by the drive assistance unit is reported, by changing the display color of the outer edges depending on the execution of the drive assistance by the drive assistance unit, or by displaying the vehicle state display part indicating the execution state of the drive assistance by the drive assistance unit on the information display unit.

Therefore, according to the drive assistance device of the present invention, it is possible to inform the driver of the vehicle of both the change in the road shape in front of the vehicle and the execution status of the drive assistance, by only the display (the shape and the color) of the right and left outer edges of the road and the display of the vehicle state display part on the information display unit. Thereby, without the visual recognition of multiple information display units and the recognition of characters, the driver can easily understand both the change in the road shape in front of the vehicle and the execution status of the drive assistance, by only the visual recognition of the right and left outer edges of the road and the vehicle state display part on the information display unit.

Further, the display control unit displays the vehicle state display part such that the vehicle state display part is superimposed on the road image portion.

According to this configuration, the driver of the vehicle can check the right and left outer edges of the road and the vehicle state display part on the information display unit, at a glance.

Further, the display control unit displays an image portion representing a steering wheel on the vehicle state display part, when drive assistance of actuating a steering mechanism of the vehicle is being executed by the drive assistance unit.

According to this configuration, the driver of the vehicle can easily recognize that the drive assistance by which the steering mechanism of the vehicle is actuated is being executed, by visually recognizing that the image portion representing the steering wheel is displayed on the vehicle state display part.

Further, the display control unit displays an image portion representing a pedal, on the vehicle state display part, when drive assistance of applying repelling force to an accelerator pedal of the vehicle is being executed by the drive assistance unit.

According to this configuration, the driver of the vehicle can easily recognize that the drive assistance by which the repelling force is applied to the accelerator pedal of the vehicle is being executed, by visually recognizing that the image portion representing the pedal is displayed on the vehicle state display part.

Further, the display control unit displays an image portion representing a tire, on the vehicle state display part, when drive assistance of stabilizing an attitude of the vehicle is being executed by the drive assistance unit.

According to this configuration, the driver of the vehicle can easily recognize that the drive assistance by which the attitude of the vehicle is stabilized is being executed, by visually recognizing that the image portion representing the tire is displayed on the vehicle state display part.

Further, the display control unit displays an image portion representing a brake lamp on the vehicle state display part, when drive assistance of decelerating the vehicle is being executed by the drive assistance unit.

According to this configuration, the driver of the vehicle can easily recognize that the drive assistance by which the vehicle is decelerated is being executed, by visually recognizing that the image portion representing the brake lamp is displayed on the vehicle state display part.

Here, vehicle drivers having a low driving skill tend to perform the drive operation slowly, compared to drivers having a high driving skill, and therefore, it is desired to report the change in the road information and the execution status of the drive assistance early.

Hence, the drive assistance device of the present invention further comprises a driving skill judgment unit configured to judge a driving skill of the driver of the vehicle, in which the display control unit alters a timing to change the display color of the outer edges, depending on the driving skill judged by the driving skill judgment unit.

According to this configuration, it is possible to report the change in the road information and the execution status of the drive assistance, at the timing depending on the skill of the driver of the vehicle.

Further, the display control unit alters the display color of the outer edges, depending on a distance from the vehicle to a curve, when the curve is detected in front of the vehicle from the road information acquired by the road information acquisition unit.

According to this configuration, it is possible to report the distance from the vehicle to the curve, by the change in the display color of the outer edges.

Further, the display control unit displays the display color of the outer edges such that the display color of the outer edges is deep at a boundary part with the road image portion and is lighter with distance from the road image portion.

This configuration allows a further easy discrimination of the road shape that is displayed on the information display unit, and particularly, is suitable for a complex road shape such as an S-shaped curve, for example.

Further, the display control unit adopts a first color as the display color of the outer edges when the drive assistance is not being executed, and adopts a second color different from the first color as the display color of the outer edges when the drive assistance of applying the repelling force to the accelerator pedal of the vehicle is being executed.

According to this configuration, the driver of the vehicle can easily recognize that the drive assistance by which the repelling force is applied to the accelerator pedal of the vehicle is being executed, by visually recognizing that the display color of the outer edges switches from the first color to the second color.

Further, the display control unit adopts a first color as the display color of the outer edges when the drive assistance is not being executed, and adopts a third color different from the first color as the display color of the outer edges when the drive assistance of actuating the steering mechanism of the vehicle is being executed.

According to this configuration, the driver of the vehicle can easily recognize that the drive assistance by which the steering mechanism of the vehicle is actuated is being executed, by visually recognizing that the display color of the outer edges switches from the first color to the third color.

Further, the drive assistance device of the present invention further comprises:
a camera to photograph a periphery of the vehicle; and
a peripheral-situation recognition unit configured to recognize a peripheral situation of the vehicle from a captured image by the camera,
in which the information display unit alters the display color of the road image portion, when the peripheral-situation recognition unit recognizes that the vehicle has come close to an obstacle or a lane division line.

According to this configuration, it is possible to report that the vehicle has come close to the obstacle or the lane marking, by the alteration of the display color of the road image portion on the information display unit.

Further, the drive assistance device of the present invention further comprises:
a camera to photograph a periphery of the vehicle; and
a peripheral-situation recognition unit configured to recognize a peripheral situation of the vehicle from a captured image by the camera,
in which the information display unit displays an image portion indicating an obstacle such that the image portion indicating the obstacle is superimposed on the road image portion, when the peripheral-situation recognition unit recognizes that the vehicle has come close to the obstacle.

According to this configuration, the image portion indicating the obstacle is displayed on the information display unit such that the image portion indicating the obstacle is superimposed on the road image portion, and thereby, the driver of the vehicle can intuitively recognize that the vehicle has come close to the obstacle.

As the acquisition source from which the road information acquisition unit acquires the road information, a captured image by the camera mounted on the vehicle, or map information included in a navigation system mounted on the vehicle can be used. However, in the method of acquiring the road information from the captured image, a complex image processing is necessary, and therefore, there is a fear that the acquisition requires a long time.

Hence, the road information acquisition unit acquires the road information from map information included in a navigation system.

According to the configuration, compared to the method with the acquisition from the captured image, it is possible to acquire the road information in a short time, and to shorten the time required for the information display unit to display the road information.

Next, a drive assistance method of the present invention is a drive assistance method of performing drive assistance for a driver of a vehicle by a drive assistance device including: a road information acquisition unit configured to acquire road information of a road on which the vehicle is traveling, the road information containing a shape of the road; an information display unit configured to display information at a position that is visible from the driver of the vehicle; and a drive assistance unit configured to perform the drive assistance for the driver of the vehicle,
the drive assistance method comprising:
a road information acquisition step of acquiring the road information by the road information acquisition unit;
a drive assistance step of performing the drive assistance by the drive assistance unit; and
a display control step of displaying the road information in front of the vehicle acquired by the road information acquisition unit on the information display unit, such that a color of a road image portion indicating the shape of the road is different from a color of right and left outer edges of the road image portion, adopting a first color as a display color of the outer edges when the drive assistance is not being executed, adopting a second color different from the first color as the display color of the outer edges when drive assistance of applying repelling force to an accelerator pedal of the vehicle is being executed, and adopting a third color different from the first color as the display color of the outer edges when drive assistance of actuating a steering mechanism of the vehicle is being executed.

According to the drive assistance method of the present invention, it is possible to inform the driver of the vehicle of both the change in the road shape in front of the vehicle and the execution status of the drive assistance, by only the display (the shape and the color) of the right and left outer edges of the road on the information display unit. It is possible to inform the driver of the vehicle that the drive assistance is not being executed, when the display color of the right and left outer edges of the road is the first color, that the drive assistance by which the repelling force is applied to the accelerator pedal of the vehicle is being executed, when the display color is the second color, and that the drive assistance by which the steering mechanism of the vehicle is actuated is being executed, when the display color is the third color.

Further, in the drive assistance method of the present invention, the drive assistance device further includes a camera to photograph a periphery of the vehicle, the drive assistance method comprises a peripheral-situation recognition step of recognizing a peripheral situation of the vehicle from a captured image by the camera, and in the display control step, an image portion indicating an obstacle is displayed on the information display unit such that the image portion indicating the obstacle is superimposed on the road image portion, when it is recognized that the vehicle has come close to the obstacle in the peripheral-situation recognition step.

According to the configuration, the image portion indicating the obstacle is displayed on the information display unit such that the image portion indicating the obstacle is superimposed on the road image portion, and thereby, the driver of the vehicle can intuitively recognize that the vehicle has come close to the obstacle.

### BRIEF DESCRIPTION OF DRAWINGS

FIG. 1 is a configuration diagram of a drive assistance device in a first embodiment.

FIG. 2 is a flowchart of a process by the drive assistance device in the first embodiment.

FIG. 3 is an explanatory diagram showing positions of a vehicle on a road.

FIG. 4A to FIG. 4C are explanatory diagrams of the display on a display device, in which FIG. 4A shows a status in which drive assistance is not being executed, FIG. 4B shows a status in which drive assistance by which repelling force is applied to an accelerator pedal is being executed, and FIG. 4C shows a status in which drive assistance by which a steering mechanism is actuated is being executed.

FIG. 5A to FIG. 5D are explanatory diagrams of the display on the display device, in which FIG. 5A shows a status in which the vehicle has come close to an obstacle or a lane marking, FIG. 5B shows a status in which the vehicle has come close to the obstacle, FIG. 5C is a modification showing a status in which the vehicle has come close to the obstacle, and FIG. 5D shows a gradation display of road outer edges.

FIG. 6 is a configuration diagram of a drive assistance device in a second embodiment.

FIG. 7 is a flowchart of a process by the drive assistance device in the second embodiment.

FIG. 8A to FIG. 8D are explanatory diagrams of the display on the display device, in which FIG. 8A shows a status in which the drive assistance is not being executed, FIG. 8B shows a status in which the drive assistance by which the repelling force is applied to the accelerator pedal is being executed, FIG. 8C shows a status in which the drive assistance by which the steering mechanism is actuated is being executed, and FIG. 8D shows a gradation display of the road outer edges.

FIG. 9A to FIG. 9C are explanatory diagrams of the display on the display device, in which FIG. 9A shows a status in which the vehicle has come close to the obstacle or the lane marking, FIG. 9B shows a status in which the vehicle has come close to the obstacle, and FIG. 9C is a modification showing a status in which the vehicle has come close to the obstacle.

### DESCRIPTION OF EMBODIMENTS

### 1. First Embodiment

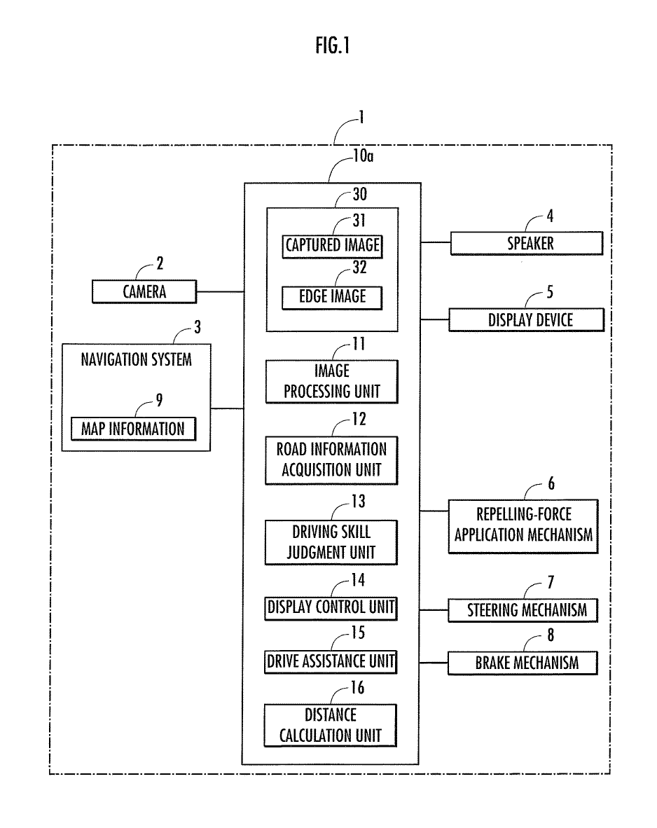

A first embodiment of a driving assistance device of the present invention will be described with reference to FIG. 1 to FIG. 5.

With reference to FIG. 1, a drive assistance device 10a in the first embodiment is mounted on a vehicle (corresponding to the vehicle in the present invention) 1 comprising a camera 2, a navigation system 3, a speaker 4, a display device 5 (corresponding to the information display unit in the present invention), a repelling-force application mechanism 6, a steering mechanism 7, and a brake mechanism 8.

The navigation system 3 includes map information 9.

The display device 5 is provided at a position that can be recognized by a driver of the vehicle 1, for example, between a speedometer and a tachometer in a meter panel.

The drive assistance device 10a is an electronic unit constituted by a CPU, a memory, various interface circuits and the like, which are not illustrated, and functions as an image processing unit 11, a road information acquisition unit 12, a driving skill judgment unit 13, a display control unit 14, a drive assistance unit 15 and a distance calculation unit 16, when the CPU executes a program for drive assistance that is held in the memory.

The image processing unit 11 acquires a color captured image 31 from a picture signal in front of the vehicle 1 that is output from the camera 2, and holds it in an image memory 30. Further, the image processing unit 11 converts the color component of each pixel of the captured image 31 into the luminance, generates a gray scale image (multi-level image), and then extracts edge points from the gray scale image to generate an edge image 32, and then, holds it in the image memory 30.

From the edge image 32, the image processing unit 11 recognizes image portions of a left lane mark for marking off the left side of a lane and a right lane mark for marking off the right side of the lane, and recognizes an image portion of an obstacle such as a pedestrian, a bicycle and the like.

The driving skill judgment unit 13 judges the driving skill of the driver of the vehicle 1, based on a history of past executions of the drive assistance.

The drive assistance unit 15 actuates the repelling-force application mechanism 6, the steering mechanism 7 or the brake mechanism 8, for example, when the speed of the approach of the vehicle 1 to a curve is too high, when the vehicle 1 has come close to the lane mark, or when there is an obstacle that should be avoided, around the vehicle 1. The drive assistance unit 15 applies, to an accelerator pedal, repelling force (force for restraining the thread force to the accelerator pedal by the driver), by the repelling-force application mechanism 6.

The drive assistance unit 15, by the steering mechanism 7, generates steering force so as to assist the steering operation by the driver. The drive assistance unit 15, by the brake mechanism 8, brakes any of tire so as to stabilize the attitude of the vehicle 1, or brakes tires so as to decelerate the vehicle 1.

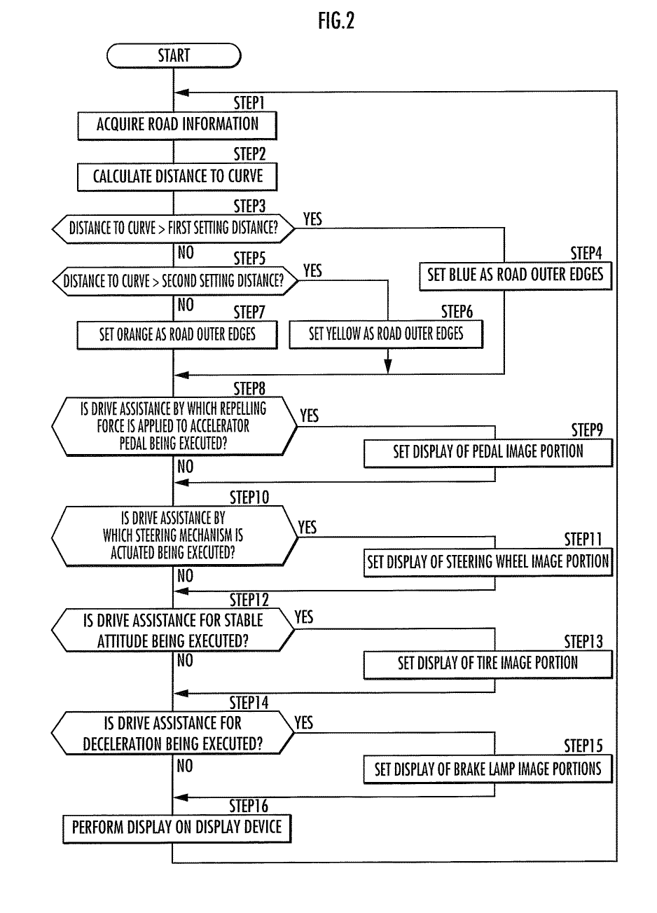

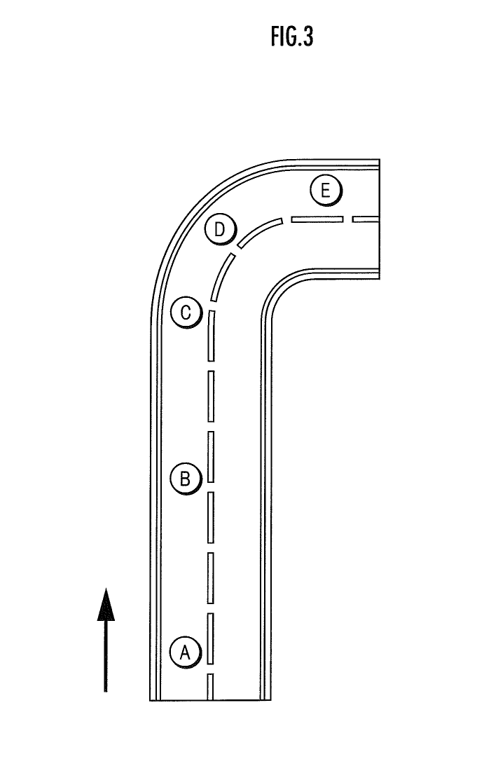

In the following, a process in which the drive assistance device 10a displays, on the display device 5, the change in the road shape in front of the vehicle 1 and the execution status of the drive assistance unit 15 will be described along a flowchart shown in FIG. 2. In the embodiment, a case where the vehicle 1 travels from a point A to a point E on a road shown in FIG. 3 will be described.

The drive assistance device 10a executes the process of the flowchart shown in FIG. 2, in a predetermined control cycle.

STEP 1 is a process by the road information acquisition unit 12. From the map information 9 of the navigation system 3, the road information acquisition unit 12 acquires the road information about the road in front of the vehicle 1, which contains the road shape.

STEP 2 is a process by the distance calculation unit 16. The distance calculation unit 16 calculates the distance from the vehicle 1 to a curve point in front of the vehicle, from the road information acquired by the road information acquisition unit 12, and the process proceeds to STEP 3.

STEP 3 to STEP 16 are processes by the display control unit 14. In STEP 3, the display control unit 14 judges whether the distance to the curve point calculated by the distance calculation unit 16 exceeds a first setting distance. In the case of exceeding the first setting distance, the process proceeds to STEP 4, and in the case of being within the first setting distance, the process proceeds to STEP 5.

Here, the case where the distance from the vehicle 1 to the curve point in front of the vehicle exceeds the first setting distance is a case where the road is a straight road within the first setting distance from the vehicle 1 and where there is no curve within the first setting distance, for example, a case where the vehicle 1 is positioned at the point A or the point E in FIG. 3.

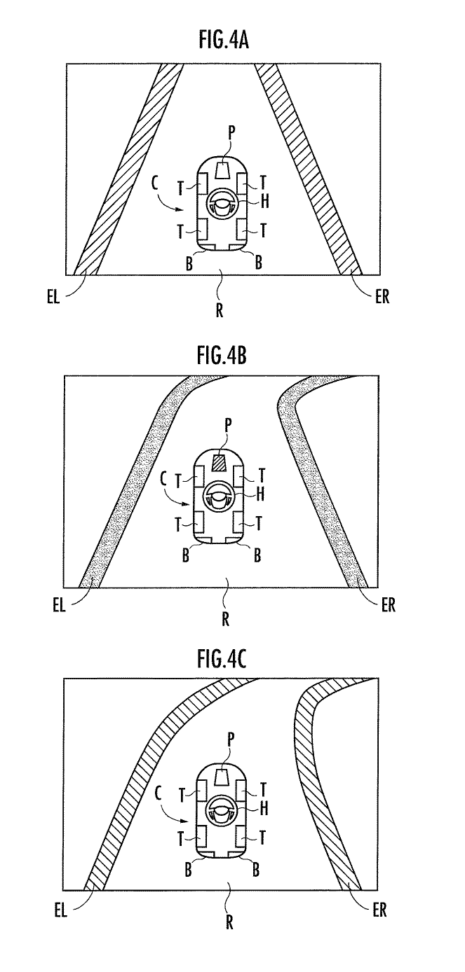

In STEP 4, the display control unit 14 sets blue as the display color of left and right outer edges EL, ER (hereinafter, referred to as road outer edges) of a road image portion R that is displayed on the display device 5 and that indicates the shape of the road (FIG. 4A), and the process proceeds to STEP 8. The road image portion R is displayed on the display device 5 based on the road shape acquired in STEP 1, and the display color is black.

In STEP 5, the display control unit 14 judges whether the distance to the curve point calculated by the distance calculation unit 16 exceeds a second setting distance (here, the second setting distance <the first setting distance). In the case of exceeding the second setting distance, the process proceeds to STEP 6, and in the case of being within the second setting distance, the process proceeds to STEP 7.

Here, the case where the distance from the vehicle 1 to the curve point in front of the vehicle exceeds the second setting distance is a case where the curve is present beyond the second setting distance and within the first setting distance from the vehicle 1, and a case where the vehicle 1 is positioned at a point B in FIG. 3. Further, the case where the distance from the vehicle 1 to the curve point in front of the vehicle is within the second setting distance is a case where the curve is present within the second setting distance from the vehicle 1, and a case where the vehicle 1 is positioned at a point C or a point D in FIG. 3.

In STEP 6, the display control unit 14 sets yellow as the display color of the road outer edges EL, ER (FIG. 4B), and the process proceeds to STEP 8.

In STEP 7, the display control unit 14 sets orange as the display color of the road outer edges EL, ER (FIG. 4C), and the process proceeds to STEP 8.

In STEPS 8 to 15, the display control unit 14 sets the display color of a vehicle state display part C that is displayed on the display device 5 so as to be superimposed on the road image portion R. As shown in FIG. 4A, the vehicle state display part C comprises a pedal image portion P representing a pedal of the vehicle 1, a steering wheel image portion H representing a steering wheel of the vehicle 1, tire image portions T representing tires of the vehicle 1, and brake lamp image portions B representing brake lamps of the vehicle 1, and all are normally displayed in gray.

In STEP 8, the display control unit 14 judges whether the drive assistance by which the repelling force is applied to the accelerator pedal by the repelling-force application mechanism 6 is being executed. In the case where the drive assistance is being executed, the process proceeds to STEP 9, and in the case where the drive assistance is not being executed, the process proceeds to STEP 10.

In STEP 9, the display control unit 14 performs such a setting that the pedal image portion P is displayed in yellow on the vehicle state display part C (FIG. 4B), and the process proceeds to STEP 10.

In STEP 10, the display control unit 14 judges whether the drive assistance by which the steering force is generated by the steering mechanism 7 such that the steering operation by the driver is assisted is being executed. In the case where the drive assistance is being executed, the process proceeds to STEP 11, and in the case where the drive assistance is not being executed, the process proceeds to STEP 12.

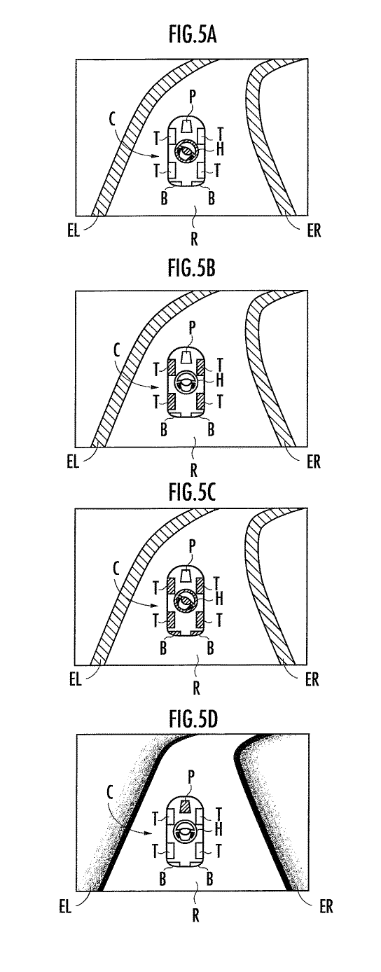

In STEP 11, the display control unit 14 displays the steering wheel image portion H in green on the vehicle state display part C, and performs such a setting that the orientation of the steering wheel image portion H is displayed corresponding to the direction in which the vehicle 1 is being operated (FIG. 5A), and the process proceeds to STEP 12.

In STEP 12, the display control unit 14 judges whether the drive assistance by which any of tire is braked by the brake mechanism 8 such that the attitude of the vehicle 1 is stabilized is being executed. In the case where the drive assistance is being executed, the process proceeds to STEP 13, and in the case where the drive assistance is not being executed, the process proceeds to STEP 14.

In STEP 13, the display control unit 14 performs such a setting that the tire image portion T of the vehicle state display part C is displayed in orange corresponding to the tire at which the vehicle 1 is being braked (FIG. 5B), and the process proceeds to STEP 14.

In STEP 14, the display control unit 14 judges whether the drive assistance by which tires are braked by the brake mechanism 8 such that the vehicle 1 is decelerated is being executed. In the case where the drive assistance is being executed, the process proceeds to STEP 15, and in the case where the drive assistance is not being executed, the process proceeds to STEP 16.

In STEP 15, the display control unit 14 performs such a setting that the brake lamp image portions B of the vehicle state display part C are displayed in red (FIG. 5C), and the process proceeds to STEP 16.

In STEP 16, the display control unit 14 displays the road image portion R on the display device 5, based on the road shape acquired in STEP 1, and colors and displays the road outer edges EL, ER, based on the setting in STEP 4, STEP 6 and STEP 7.

Furthermore, the display control unit 14 displays the vehicle state display part C such that the vehicle state display part C is superimposed on the road image portion R, and colors and displays the pedal image portion P, the steering wheel image portion H, the tire image portions T and the brake lamp image portions B, based on the setting in STEP 9, STEP 11, STEP 13 and STEP 15.

FIG. 4A shows the display state of the display device 5 for the case where it is judged that the distance from the vehicle 1 to the curve exceeds the first setting distance in STEP 3 and where it is judged that no drive assistance is being executed in STEP 8, STEP 10, STEP 12 and STEP 14.

In FIG. 4A, the road image portion R is displayed in black, the road outer edges EL, ER are displayed in blue, which is different from the color of the road image portion R, and the pedal image portion P, steering wheel image portion H, tire image portions T and brake lamp image portions B of the vehicle state display part C are each displayed in gray.

FIG. 4B shows the display state of the display device 5 for the case where it is judged that the distance from the vehicle 1 to the curve is within the first setting distance and exceeds the second setting distance in STEP 5 and where it is judged that only the drive assistance by which the repelling force is applied to the accelerator pedal by the repelling-force application mechanism 6 is being executed in STEP 8, STEP 10, STEP 12 and STEP 14.

In FIG. 4B, the road image portion R is displayed in black, the road outer edges EL, ER are displayed in yellow, which is different from the color of the road image portion R, the steering wheel image portion H, tire image portions T and brake lamp image portions B of the vehicle state display part C are each displayed in gray, and the pedal image portion P is displayed in yellow.

FIG. 4C shows the display state of the display device 5 for the case where it is judged that the distance from the vehicle 1 to the curve is within the second setting distance in STEP 5 and where it is judged that no drive assistance is being executed in STEP 8, STEP 10, STEP 12 and STEP 14.

In FIG. 4C, the road image portion R is displayed in black, the road outer edges EL, ER are displayed in orange, which is different from the color of the road image portion R, and the pedal image portion P, steering wheel image portion H, tire image portions T and brake lamp image portions B of the vehicle state display part C are each displayed in gray.

FIG. 5A shows the display state of the display device 5 for the case where it is judged that the distance from the vehicle 1 to the curve is within the second setting distance in STEP 5 and where it is judged that only the drive assistance by which the steering force is generated by the steering mechanism 7 such that the steering operation by the driver is assisted is being executed in STEP 8, STEP 10, STEP 12 and STEP 14.

In FIG. 5A, the road image portion R is displayed in black, the road outer edges EL, ER are displayed in orange, which is different from the color of the road image portion R, the pedal image portion P, tire image portions T and brake lamp image portions B of the vehicle state display part C are displayed in gray, and the steering wheel image portion H is displayed in green. The orientation of the steering wheel image portion H corresponds to the direction in which the vehicle 1 is being operated.

FIG. 5B shows the display state of the display device 5 for the case where it is judged that the distance from the vehicle 1 to the curve is within the second setting distance in STEP 5 and where it is judged that only the drive assistance by which any of tire is braked by the brake mechanism 8 such that the attitude of the vehicle 1 is stabilized is being executed in STEP 8, STEP 10, STEP 12 and STEP 14.

In FIG. 5B, the road image portion R is displayed in black, the road outer edges EL, ER are displayed in orange, which is different from the color of the road image portion R, the pedal image portion P, steering wheel image portion H and brake lamp image portions B of the vehicle state display part C are displayed in gray, and the tire image portion T corresponding to the tire at which the braking is being performed is displayed in orange.

FIG. SC shows the display state of the display device 5 for the case where it is judged that the distance from the vehicle 1 to the curve is within the second setting distance in STEP 5 and where it is judged that three types of drive assistance, the drive assistance by which the steering force is generated by the steering mechanism 7 such that the steering operation by the driver is assisted, the drive assistance by which one of the tires is braked such that the attitude of the vehicle 1 is stabilized, and the drive assistance by which tires are braked such that the vehicle 1 is decelerated, are being executed in STEP 8, STEP 10, STEP 12 and STEP 14.

In FIG. SC, the road image portion R is displayed in black, the road outer edges EL, ER are displayed in orange, which is different from the color of the road image portion R, the pedal image portion P of the vehicle state display part C is displayed in gray, the steering wheel image portion H is displayed in green, the tire image portion T corresponding to the tire at which the braking is being performed is displayed in orange, and the brake lamp image portion B is displayed in red.

Therefore, according to the drive assistance device 10a, it is possible to inform the driver of the vehicle 1 of both the change in the road shape in front of the vehicle 1 and the execution status of the drive assistance, by only the display (the shape and the color) of the road outer edges EL, ER and the display of the vehicle state display part C on the display device 5.

Thereby, without the visual recognition of multiple information display units and the recognition of characters, the driver can easily understand both the change in the road shape in front of the vehicle 1 and the execution status of the drive assistance, by only the visual recognition of the road outer edges EL, ER and the vehicle state display part C on the display device 5.

In FIG. 4A to FIG. 4C and FIG. 5A to FIG. 5C, the road outer edges EL, ER are displayed as lines that have a single solid color and that have a predetermined width. However, as shown in FIG. 5D, the display (gradation display) may be performed such that the display color of the road outer edges EL, ER is deep at boundary parts with the road image portion R and is lighter with distance from the road image portion R. The gradation display allows a further easy discrimination of the change in the road shape that is displayed on the display device 5, and particularly, is suitable for a complex road shape such as an S-shaped curve, for example.

According to the drive assistance device 10a in the first embodiment, it is possible to acquire the road information from the map information 9 of the navigation system 3, in a short time, and to shorten the time required for the display device 5 to display the road information. Instead of this method, the road information may be acquired from the captured image by the camera 2.

Further, the driving skill judgment unit 13 may judge the driving skill of the driver of the vehicle 1, and the drive assistance device 10a in the first embodiment may alter the timing of the information display on the display device 5, depending on the judged driving skill. For example, in the case of judging that the driver has a low driving skill, the timing of the information display on the display device 5 is advanced compared to drivers having a high driving skill, and thereby, it is possible to report the change in the road information and the execution status of the drive assistance early.

### 2. Second Embodiment

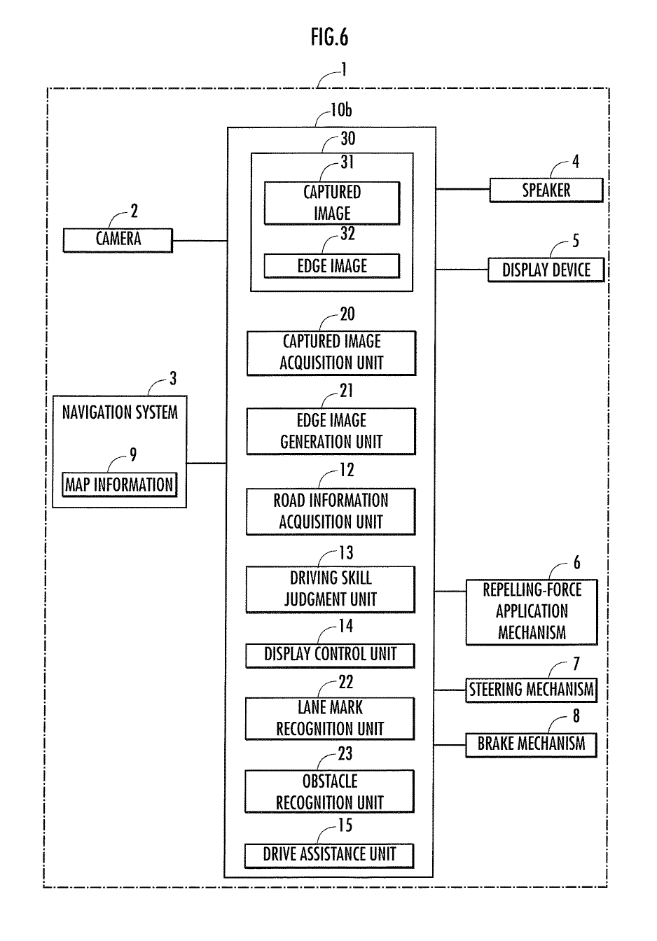

Next, a second embodiment of the drive assistance device of the present invention will be described with reference to FIG. 6 to FIG. 9.

With reference to FIG. 6, a drive assistance device 10b in the second embodiment is mounted on a vehicle 1 (corresponding to the vehicle in the present invention) comprising the camera 2, the navigation system 3, the speaker 4, the display device 5 (corresponding to the information display unit in the present invention), the repelling-force application mechanism 6, the steering mechanism 7 and the brake mechanism 8, similarly to the above-described drive assistance device 10a in the first embodiment.

The drive assistance device 10b is an electronic unit constituted by a CPU, a memory, various interface circuits and the like, which are not illustrated, and functions as a captured image acquisition unit 20, an edge image generation unit 21, the road information acquisition unit 12, the driving skill judgment unit 13, the display control unit 14, a lane mark recognition unit 22, an obstacle recognition unit 23 and the drive assistance unit 15, when the CPU executes a program for drive assistance that is held in the memory.

The lane mark recognition unit 22 and the obstacle recognition unit 23 correspond to the peripheral-situation recognition unit in the present invention. For the same constitutions as the drive assistance device 10a in the first embodiment, identical reference numerals are assigned, and the descriptions are omitted.

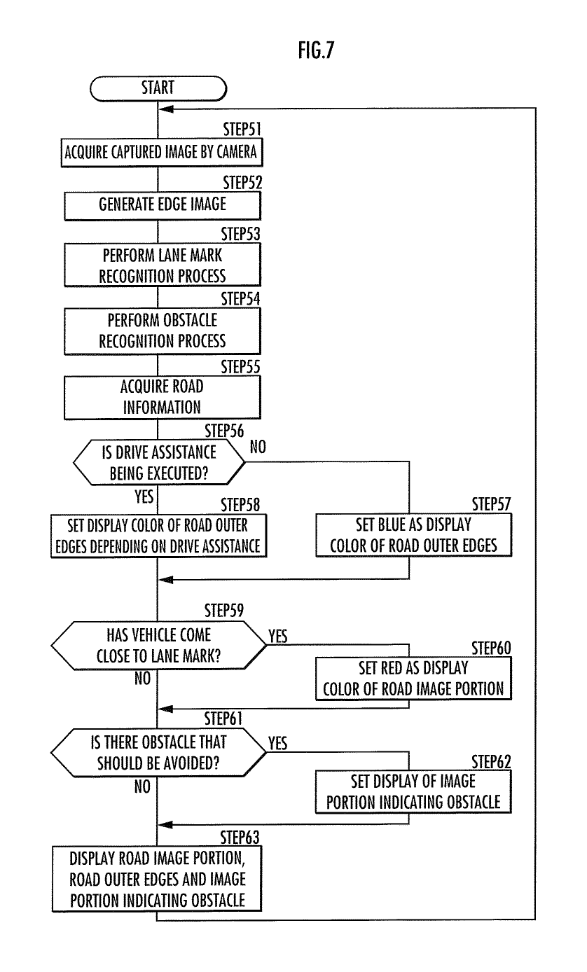

In the following, a process in which the drive assistance device 10b displays, on the display device 5, the change in the road shape in front of the vehicle 1 and the execution status of the drive assistance unit 15 will be described along a flowchart shown in FIG. 7.

The drive assistance device 10b executes the process of the flowchart shown in FIG. 7, in a predetermined control cycle.

STEP 51 in FIG. 7 is a process by the captured image acquisition unit 20. The captured image acquisition unit 20 receives a picture signal in front of the vehicle 1 that is output from the camera 2, performs the demosaicing of the color component (R-value, G-value and B-value) of the picture signal, and acquires a color captured image 31 having the R-value, the G-value and the B-value as the data of the each pixel. The data of the acquired captured image 31 is held in the image memory 30.

STEP 52 is a process by the edge image generation unit 21. The edge image generation unit 21 performs a process of converting the color component of each pixel of the captured image 31 into the luminance, and generates a gray scale image (multi-level image). Then, the edge image generation unit 21 extracts, from the gray scale image, edge points (pixels for each of which the luminance difference (the change amount of luminance) from a pixel at a peripheral part (image portion) is a predetermined value or more; the edge points include positive edge points where the luminance changes from dark to light and negative edge points where the luminance changes from light to dark), and generates an edge image 32. The edge image 32 is held in the image memory 30.

Here, in the case where the camera 2 is a monochromatic camera, the gray scale captured image is obtained from the luminance of each pixel, and therefore, the above-described process of generating the gray scale image from the color captured image is unnecessary.

STEP 53 is a process (lane mark recognition process) by the lane mark recognition unit 22. The lane mark recognition unit 22 recognizes image portions of a left lane mark for marking off the left side of a lane and a right lane mark for marking off the right side of the lane, from the edge image 32 generated by the edge image generation unit 21.

STEP 54 is a process (obstacle recognition process) by the obstacle recognition unit 23. The obstacle recognition unit 23 recognizes an image portion of an obstacle such as a pedestrian, a bicycle and the like, from the edge image 32 generated by the edge image generation unit 21.

STEP 55 is a process by the road information acquisition unit 12. The road information acquisition unit 12 acquires the road information about the road in front of the vehicle 1, which contains the road shape, from the map information 9 of the navigation system 3.

STEP 56 to STEP 63 are processes by the display control unit 14. In STEP 56, the display control unit 14 judges whether the drive assistance is being executed by the drive assistance unit 15. In the case where the drive assistance is not being executed at all, the process proceeds to STEP 57, and in the case where the drive assistance is being executed, the process proceeds to STEP 58.

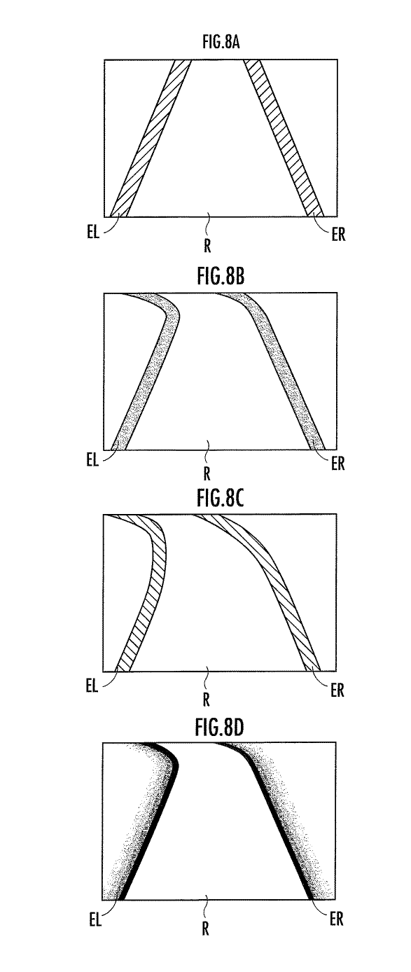

In STEP 57, the display control unit 14 sets blue (corresponding to the first color in the present invention), which is different from the color of the road image portion R, as the display color of the left and right outer edges (hereinafter, referred to as the road outer edges) EL, ER of the road image portion R that is displayed on the display device 5 and that indicates the shape of the road (FIG. 8A), and the process proceeds to STEP 59. The road image portion R is displayed on the display device 5 based on the road shape acquired in STEP 55, and the display color is black (except when the distance from the vehicle 1 to the lane mark is less than a predetermined distance, as described below).

In STEP 58, the display control unit 14 sets the display color of the road outer edges EL, ER, depending on the execution status of the drive assistance by the drive assistance unit 15, and the process proceeds to STEP 59. In the case where the drive assistance by which the repelling force is applied to the accelerator pedal by the repelling-force application mechanism 6 is being executed, the display control unit 14 sets yellow (corresponding to the second color in the present invention) as the display color of the road outer edges EL, ER (FIG. 8B).

In the case where the drive assistance by which the steering force is generated by the steering mechanism 7 such that the steering operation by the driver is assisted is being executed, the display control unit 14 sets orange (corresponding to the third color in the present invention) as the display color of the road outer edges EL, ER (FIG. 8C).

In STEP 59, the display control unit 14 judges whether the distance from the vehicle 1 to the lane mark is less than the predetermined distance, based on the image portion of the lane mark recognized by the lane mark recognition unit 22. In the case where the distance is less than the predetermined distance and the vehicle 1 has come close to the lane mark, the process proceeds to STEP 60, and in the case where the distance is the predetermined distance or more and the vehicle 1 has not come close to the lane mark, the process proceeds to STEP 61.

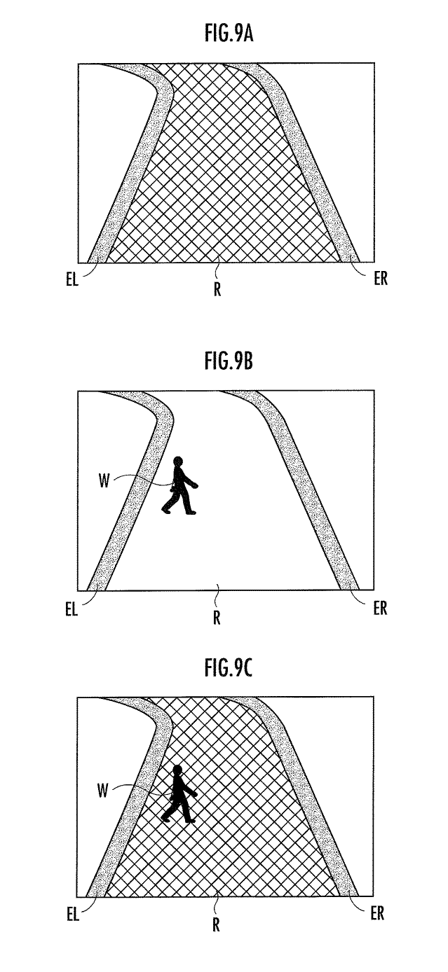

In STEP 60, the display control unit 14 sets red as the display color of the road image portion R displayed on the display device 5, that is, the portion sandwiched between the road outer edges EL, ER (see FIG. 9A), and the process proceeds to STEP 61.

In STEP 61, the display control unit 14 judges whether there is an obstacle that should be avoided, based on the image portion of the obstacle acquired by the obstacle recognition unit 23. In the case where there is an obstacle that should be avoided because of the distance from the vehicle 1 to the obstacle, the orientation of the obstacle and the like, the process proceeds to STEP 62, and in the case where there is not an obstacle that should be avoided, the process proceeds to STEP 63.

In STEP 62, the display control unit 14 performs such a setting that an image portion W indicating the obstacle is displayed on the display device 5 so as to be superimposed on the road image portion R (see FIG. 9B), and the process proceeds to STEP 63.

In STEP 63, the display control unit 14 displays the road image portion R on the display device 5, based on the road shape acquired in STEP 55 and the setting in STEP 60, and displays the road outer edges EL, ER and the image portion W indicating the obstacle, based on the setting in STEP 57, STEP 58 and STEP 62.

FIG. 8A shows the display state of the display device 5 for the case where it is judged that the drive assistance is not being executed in STEP 56, where it is judged that the vehicle 1 has not come close to the lane mark in STEP 59, and where it is judged that there is not an obstacle that should be avoided in STEP 61. In FIG. 8A, the road image portion R is displayed in black, and the road outer edges EL, ER are displayed in blue, which is different from the color of the road image portion R.

FIG. 8B shows the display state of the display device 5 for the case where it is judged that the drive assistance by which the repelling force is applied to the accelerator pedal of the vehicle 1 is being executed in STEP 58, where it is judged that the vehicle 1 has not come close to the lane mark in STEP 59, and where it is judged that there is not an obstacle that should be avoided in STEP 61. In FIG. 8B, the road image portion R is displayed in black, and the road outer edges EL, ER are displayed in yellow, which is different from the color of the road image portion R.

FIG. 8C shows the display state of the display device 5 for the case where it is judged that the drive assistance by which the steering wheel of the vehicle 1 is steered is being executed in STEP 58, where it is judged that the vehicle 1 has not come close to the lane mark in STEP 59, and where it is judged that there is not an obstacle that should be avoided in STEP 61. In FIG. 8C, the road image portion R is displayed in black, and the road outer edges EL, ER are displayed in orange, which is different from the color of the road image portion R.

Therefore, according to the drive assistance device 10b, it is possible to inform the driver of the vehicle 1 of both the change in the road shape in front of the vehicle 1 and the execution status of the drive assistance, by only the display (the shape and the color) of the road outer edges EL, ER on the display device 5. Thereby, without the visual recognition of multiple information display units and the recognition of characters, the driver can easily understand both the change in the road shape in front of the vehicle 1 and the execution status of the drive assistance, by only the visual recognition of the road outer edges EL, ER on the display device 5.

In FIG. 8A to FIG. 8C, the road outer edges EL, ER are displayed as lines that have a single solid color and that have a predetermined width. However, as shown in FIG. 8D, the display (gradation display) may be performed such that the display color of the road outer edges EL, ER is deep at boundary parts with the road image portion R and is lighter with distance from the road image portion R. The gradation display allows a further easy discrimination of the change in the road shape that is displayed on the display device 5, and particularly, is suitable for a complex road shape such as an S-shaped curve, for example.

FIG. 9A shows the display state of the display device 5 for the case where it is judged that the drive assistance by which the repelling force is applied to the accelerator pedal of the vehicle 1 is being executed in STEP 58, where it is judged that the vehicle 1 has come close to the lane mark in STEP 59, and where it is judged that there is not an obstacle that should be avoided in STEP 61. In FIG. 9A, the road image portion R is displayed in red, and the road outer edges EL, ER are displayed in yellow, which is different from the color of the road image portion R.

FIG. 9B shows the display state of the display device 5 for the case where it is judged that the drive assistance by which the repelling force is applied to the accelerator pedal of the vehicle 1 is being executed in STEP 58, where it is judged that the vehicle 1 has not come close to the lane mark in STEP 59, and where it is judged that there is an obstacle that should be avoided in STEP 62.

In FIG. 9B, the road image portion R is displayed in black, the road outer edges EL, ER are displayed in yellow, and the image portion W indicating the obstacle is displayed so as to be superimposed on the road image portion R. As the image portion W indicating the obstacle, the image portion of the obstacle in the captured image 31 may be extracted, or an icon or the like indicating the obstacle may be adopted.

Therefore, according to the drive assistance device 10b, it is possible to inform the driver of the vehicle 1, of the peripheral situation of the vehicle 1 about whether the vehicle 1 has come close to the lane mark and whether there is an obstacle that should be avoided, in addition to the change in the road shape in front of the vehicle 1 and the execution status of the drive assistance.

Further, in the case where it is judged that there is an obstacle that should be avoided in STEP 61, as shown in FIG. 9C, the road image portion R may be displayed in red while the image portion W indicating the obstacle is displayed so as to be superimposed on the road image portion R.

According to the drive assistance device 10b in the second embodiment, it is possible to acquire the road information from the map information 9 of the navigation system 3, in a short time, and to shorten the time required for the display device 5 to display the road information. Instead of this method, the road information may be acquired from the captured image 31 by the camera 2.

Further, the driving skill judgment unit 13 may judge the driving skill of the driver of the vehicle 1, and the drive assistance device 10a in the second embodiment may alter the timing of the information display on the display device 5, depending on the judged driving skill. For example, in the case of judging that the driver has a low driving skill, the timing of the information display on the display device 5 is advanced compared to drivers having a high driving skill, and thereby, it is possible to report the change in the road information and the execution status of the drive assistance early.

### REFERENCE SIGNS LIST

1 . . . vehicle (own vehicle), 5 . . . display device (information display unit), 7 . . . steering mechanism, 9 . . . map information, 10 . . . drive assistance device, 12 . . . road information acquisition unit, 13 . . . driving skill judgment unit, 14 . . . display control unit, 15 . . . drive assistance unit, 20 . . . captured image acquisition unit, 21 . . . edge image generation unit, 22 . . . lane mark recognition unit (peripheral-situation recognition unit), 23 . . . obstacle recognition unit (peripheral-situation recognition unit), B . . . image portion representing brake lamp, C . . . vehicle state display part, EL, ER . . . road outer edge, H . . . image portion representing steering wheel, P . . . image portion representing pedal, R . . . road image portion, T . . . image portion representing tire, W . . . image portion indicating obstacle

1. A drive assistance device comprising:
a road information acquisition unit configured to acquire road information of a road on which a vehicle is traveling, the road information containing a shape of the road;
an information display unit configured to display information at a position that is visible from a driver of the vehicle;
a drive assistance unit configured to perform a plurality of types of drive assistance for the driver of the vehicle; and
a display control unit configured to display the road information in front of the vehicle acquired by the road information acquisition unit on the information display unit, such that a color of a road image portion indicating the shape of the road is different from a color of right and left outer edges of the road image portion, and to report an execution state of the drive assistance by the drive assistance unit by changing a display color of the entire outer edges depending on the type of drive assistance being executed by the drive assistance unit.

2. The drive assistance device according to claim 1,
wherein the display control unit displays the vehicle state display part which indicates the execution state of the drive assistance by the drive assistance unit such that the vehicle state display part is superimposed on the road image portion.

3. The drive assistance device according to claim 2,
wherein the display control unit displays an image portion representing a steering wheel on the vehicle state display part, when drive assistance of actuating a steering mechanism of the vehicle is being executed by the drive assistance unit.

4. The drive assistance device according to claim 2,
wherein the display control unit displays an image portion representing a pedal on the vehicle state display part, when drive assistance of applying repelling force to an accelerator pedal of the vehicle is being executed by the drive assistance unit.

5. The drive assistance device according to claim 2,
wherein the display control unit displays an image portion representing a tire on the vehicle state display part, when drive assistance to stabilize an attitude of the vehicle is being executed by the drive assistance unit.

6. The drive assistance device according to claim 2,
wherein the display control unit displays an image portion representing a brake lamp, on the vehicle state display part, when drive assistance of decelerating the vehicle is being executed by the drive assistance unit.

7. The drive assistance device according to claim 1, further comprising a driving skill judgment unit configured to judge a driving skill of the driver of the vehicle,
wherein the display control unit alters a timing to change the display color of the outer edges and the display of the vehicle state display part, depending on the driving skill judged by the driving skill judgment unit.

8. The drive assistance device according to claim 1,
wherein the display control unit alters the display color of the outer edges, depending on a distance from the vehicle to a curve, when the curve is detected in front of the vehicle from the road information acquired by the road information acquisition unit.

9. The drive assistance device according to claim 1,
wherein the display control unit displays the display color of the outer edges such that the display color of the outer edges is deep at a boundary part with the road image portion and is lighter with distance from the road image portion.

10. The drive assistance device according to claim 1,
wherein the display control unit adopts a first color as the display color of the entire outer edges when the drive assistance is not being executed, and adopts a second color different from the first color as the display color of the entire outer edges when the drive assistance of applying repelling force to an accelerator pedal of the vehicle is being executed., and adopts a third color different from the first color and the second color as the display color of the entire outer edges when the drive assistance of actuating a steering mechanism of the vehicle is being executed.

11. (canceled)

12. The drive assistance device according to claim 10, further comprising a driving skill judgment unit configured to judge a driving skill of the driver of the vehicle,
wherein the display control unit alters a timing to change the display color of the outer edges, depending on the driving skill judged by the driving skill judgment unit.

13. The drive assistance device according to claim 10,
wherein the display control unit displays the display color of the outer edges such that the display color of the outer edges is deep at a boundary part with the road image portion and is lighter with distance from the road image portion.

14. The drive assistance device according to claim 1, further comprising:
a camera to photograph a periphery of the vehicle; and
a peripheral-situation recognition unit configured to recognize a peripheral situation of the vehicle from a captured image by the camera,
wherein the information display unit alters the display color of the road image portion, when the peripheral-situation recognition unit recognizes that the vehicle has come close to an obstacle or a lane division line.

15. The drive assistance device according to claim 1, further comprising:
a camera to photograph a periphery of the vehicle; and
a peripheral-situation recognition unit configured to recognize a peripheral situation of the vehicle from a captured image by the camera,
wherein the information display unit displays an image portion indicating an obstacle such that the image portion indicating the obstacle is superimposed on the road image portion, when the peripheral-situation recognition unit recognizes that the vehicle has come close to the obstacle.

16. The drive assistance device according to claim 1,
wherein the road information acquisition unit acquires the road information from map information included in a navigation system.

17. A drive assistance method of performing drive assistance for a driver of a vehicle by a drive assistance device including: a road information acquisition unit configured to acquire road information of a road on which the vehicle is traveling, the road information containing a shape of the road; an information display unit configured to display information at a position that is visible from the driver of the vehicle; and a drive assistance unit configured to perform the drive assistance for the driver of the vehicle,
the drive assistance method comprising:
a road information acquisition step of acquiring the road information by the road information acquisition unit;
a drive assistance step of performing the drive assistance by the drive assistance unit; and
a display control step of displaying the road information in front of the vehicle acquired by the road information acquisition unit on the information display unit, such that a color of a road image portion indicating the shape of the road is different from a color of right and left outer edges of the road image portion, adopting a first color as a display color of the entire outer edges when the drive assistance is not being executed, adopting a second color different from the first color as the display color of the entire outer edges when drive assistance of applying repelling force to an accelerator pedal of the vehicle is being executed, and adopting a third color different from the first color and the second color as the display color of the entire outer edges when drive assistance of actuating a steering mechanism of the vehicle is being executed.

18. The drive assistance method according to claim 17,
wherein the drive assistance device further includes a camera to photograph a periphery of the vehicle,
the drive assistance method comprises a peripheral-situation recognition step of recognizing a peripheral situation of the vehicle from a captured image by the camera, and
in the display control step, an image portion indicating an obstacle is displayed on the information display unit such that the image portion indicating the obstacle is superimposed on the road image portion, when it is recognized that the vehicle has come close to the obstacle in the peripheral-situation recognition step.
